(19) United States
(12) Patent Application Publication
(10) Pub. No.: US 2019/0060851 A1
(43) Pub. Date: Feb. 28, 2019

(54) Chemical Mixer Tool and Drum Assembly

(71) Applicant: Taylor-Cain Corporation, Golden, CO (US)

(72) Inventors: Stephen CAIN, Castle Rock, CO (US); Dennis A. VANCE, Edwardsburg, MI (US)

(21) Appl. No.: 16/053,984

(22) Filed: Aug. 3, 2018

Related U.S. Application Data
(60) Provisional application No. 62/540,825, filed on Aug. 3, 2017.

(51) Int. Cl. B01F 7/00; B01F 3/08; B01F 13/00

(52) U.S. Cl. CPC B01F 7/00633; B01F 3/0853; B01F 2215/0036; B01F 13/002; B01F 7/00291

(57) ABSTRACT

The present invention involves a drum assembly including a barrel having a top and a bottom. The top has a valve port and a mixer port. The bottom has a downwardly conical shape. The barrel interior storage extends from the top to the conical center of the bottom for extracting liquid from the barrel. The mixer port supports a mixer tool having a shaft with mixing paddles extending into the interior of the barrel.

### CROSS-REFERENCE TO RELATED APPLICATIONS

The present application is a nonprovisional application claiming priority under 35 U.S.C. § 119(e) to U.S. Provisional Patent Application Ser. No. 62/540,825, filed Aug. 3, 2017, the disclosures of which are herein incorporated by reference.

### BACKGROUND OF THE INVENTION

### Field of the Invention

The field of the invention is that of storage containers and mixing mechanisms. More particularly, the invention deals with tool attachments and drums for chemical storage, transportation and mixing.

### Description of the Related Art

A drum is a cylindrical container used for shipping bulk cargo. Drums can be made of steel, dense paperboard (commonly called a fiber drum), or plastics, and are generally used for the transportation and storage of liquids and powders. Drums are often certified for shipment of dangerous goods. Shipped goods must be matched with the make of drum necessary to comply with applicable regulations. Drums are also called barrels in common usage. Drums/barrels are commonly used in transporting and processing industrial chemicals, fuels, and oils, as well as in agricultural environments. Various other applications include special liquid material handling, fragrances, cleaning supplies, etc.

Often in industrial settings various chemicals need to be combined in certain proportions to enable a particular result. Different mechanisms exist which allow for the combination and mixing of chemical compounds, which are often part of a large processing facility. However, there are occasions when humans must directly mix such chemicals, in which case hand held tools are a good solution.

### SUMMARY

The present invention relates to an assembly for connecting to a power tool, which assembly provides a mixing head for mixing chemicals within a drum barrel. The drum barrel is designed to optimize efficient storage and transportation, as well as liquid extraction. The assembly connects the rotating power tool head with an agitating mechanism that when submersed in a liquid agitates the liquid for mixing the component chemicals.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a side cut-away view of a chemical drum and mixer assembly according to an embodiment of the present invention.

FIG. 2 is a side cut-away view of a second embodiment of a chemical drum and mixer assembly according to another embodiment of the present invention.

FIG. 3 is a side view of several chemical drum and mixer assemblies positioned on a pallet.

FIG. 4 is a top plan view of the several chemical drum and mixer assemblies of FIG. 3.

FIG. 5A is a prospective view of a mixer attachment according to an embodiment of the present invention.

FIG. 5B is a prospective view of a mixer attachment according to another embodiment of the present invention.

FIG. 6 is a second prospective view of the mixer attachment of FIG. 5A.

FIG. 7A is a top plan view of the mixer attachment of FIG. 5A.

FIG. 7B is a top plan view of the mixer attachment of FIG. 5B.

FIG. 8 is an exploded view of the components of a mixer attachment according to an embodiment of the present invention.

FIG. 9 is an exploded view of the bushing of FIG. 8 according to one embodiment of the present invention.

FIG. 10 is a graph of the extraction performance of an embodiment of the present invention compared to a conventional drum.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiments disclosed below is/are not intended to be exhaustive or limit the invention to the precise form disclosed in the following detailed description. Rather, the embodiment is chosen and described so that others skilled in the art may utilize its teachings.

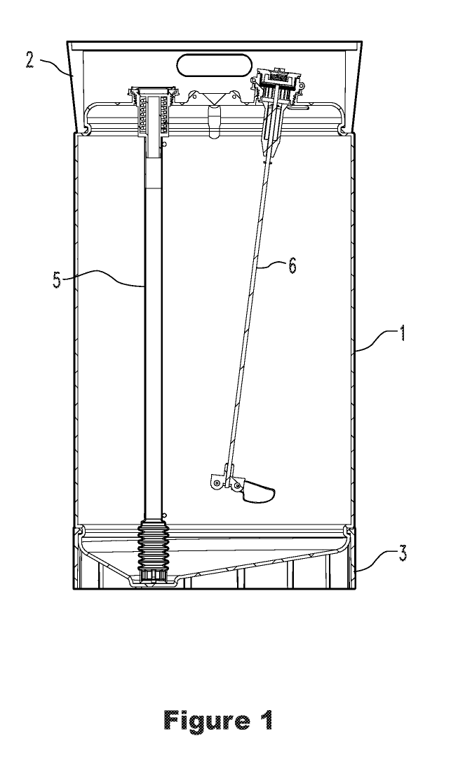

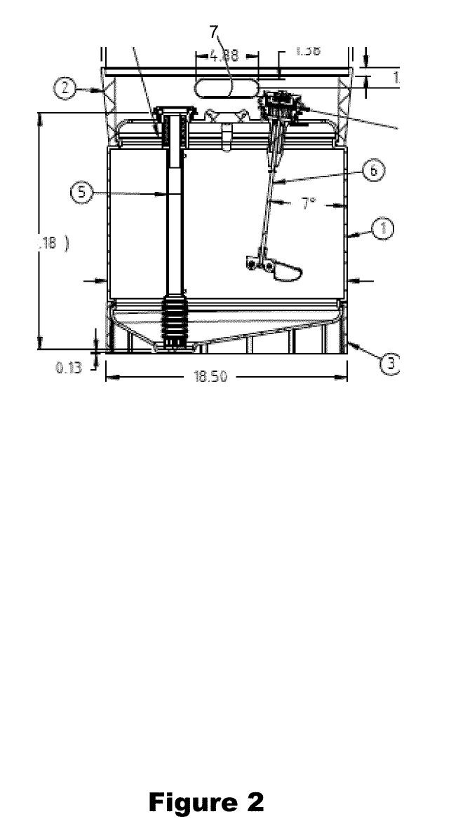

FIGS. 1 and 2 show different embodiments of a drum according the present invention. In the exemplary embodiment of FIG. 1, drum barrel 1 has a capacity of about 30 gallons. Drum barrel 1 has a generally cylindrical shape, with a top having at least two access ports including a pump valve port and a mixer head port. Extending upwardly above the top of drum barrel 1 is upper chime 2 having a plurality of support ribs circumferentially and externally disposed with optional oppositely opposed hand grip holes 7. Lower chime 3 provides a conical bottom for drum barrel 1, and valve 5 extends from the valve port to lower chime 3 in the conical center. Mixer head 6 extends downwardly into the cavity of drum barrel 1 with one or more mixing blades disposed along its central shaft for mixing and agitating chemicals within drum barrel 1. This arrangement allows valve 5, when activated, to extract almost entirely all of any liquids within drum barrel 1. FIG. 2 shows a similar configuration, but one that is shorter than the exemplary embodiment of FIG. 1. For example, the exemplary embodiment of FIG. 2 has a similar cylindrical shape and diameter, just having a shorter axis, and holds approximately 15 gallons of liquid.

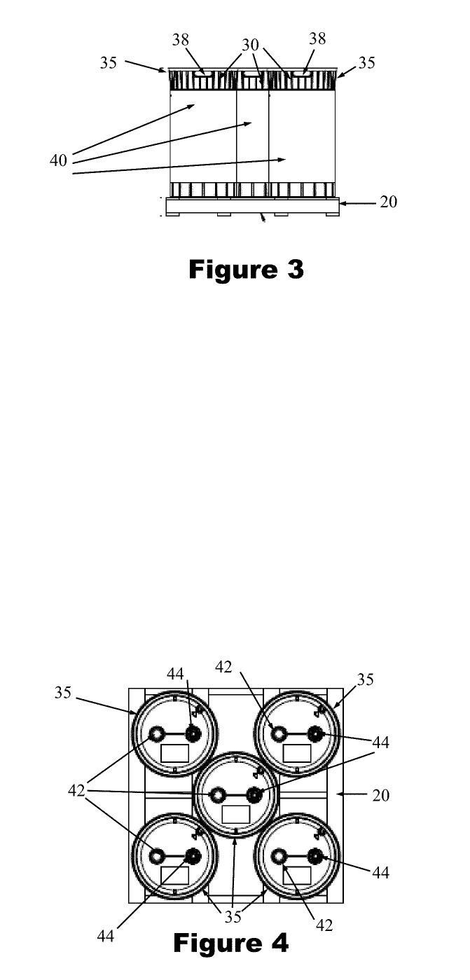

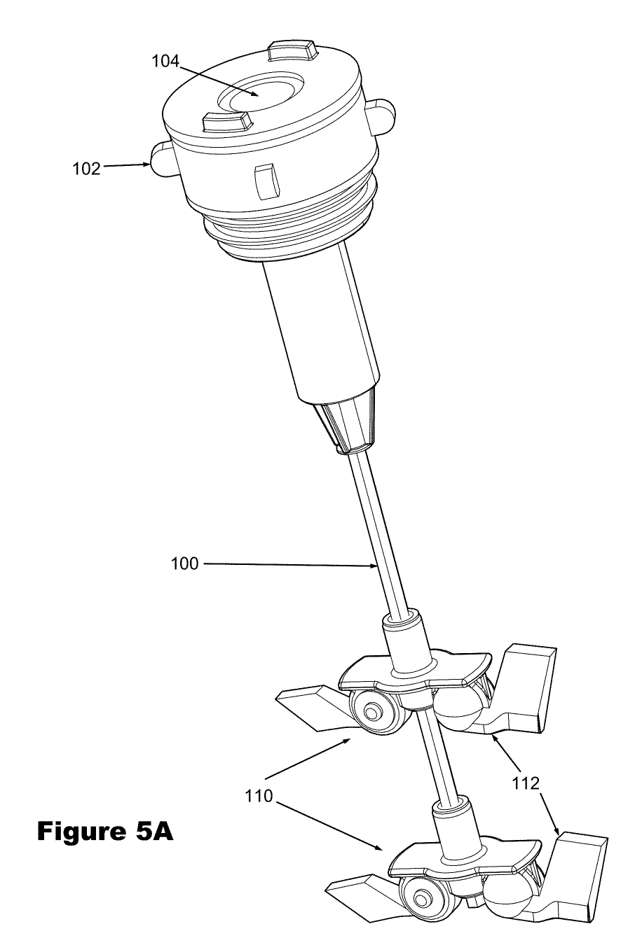

FIGS. 3 and 4 show how the embodiments of FIGS. 1 and 2 may be positioned together for storage and shipping. In FIGS. 3 and 4, ribs 30 of upper chimes 35 interlock to secure the position of drum barrels 40 on a conventional pallet 20. Optionally, the various drum barrels may be wrapped together by plastic bands, or other wrapping material. Valve ports 42 and mixer ports 44 are accessible from the top, allowing for drum barrels to be accessed while still in the shipping configuration. Upper chimes 35 further include handles 38 to allow for manual lifting of each barrel 40.

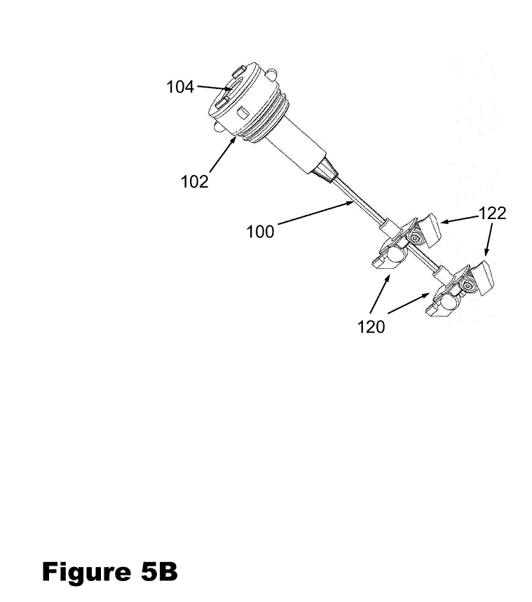

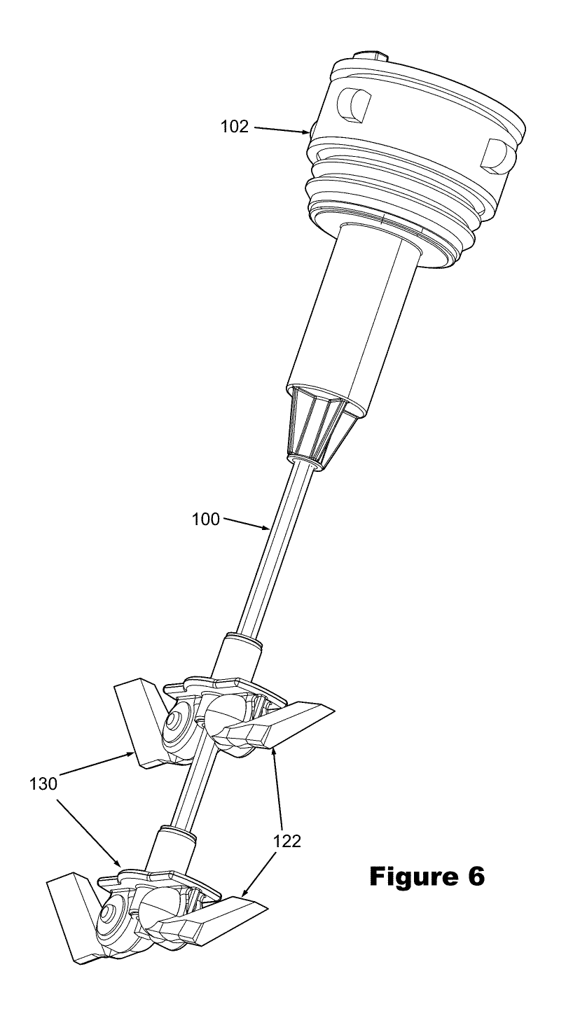

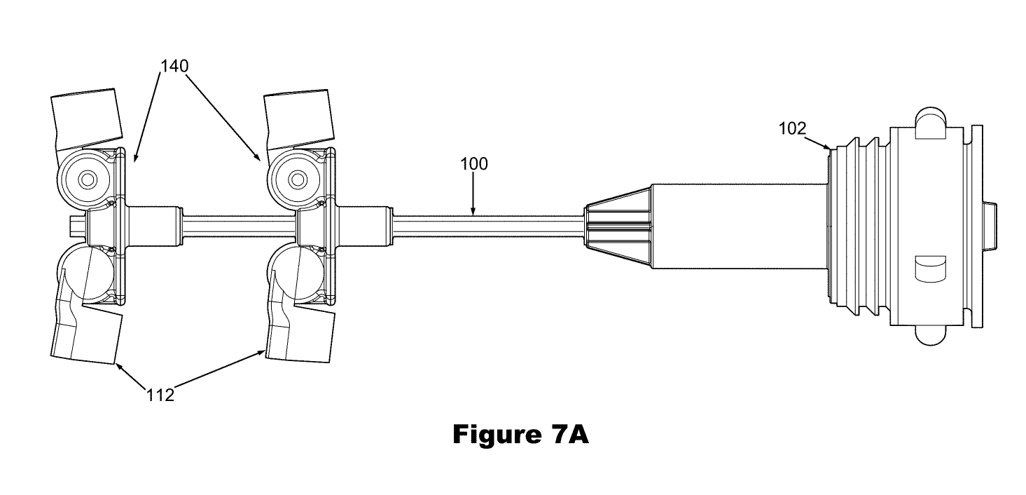

FIGS. 5-7 show one exemplary embodiment of the mixer tool, which is configured to be driven by a hand-held rotary drill tool (not shown). The mixer tool has a central hexagonal shaft 100, optionally made of metal or other suitable material, for easy alignment with socket wrenches and drills, for example electric and pneumatic hand drills. The top of the shaft has a bushing/bearing 102 setup configured for interfacing with a suitable drill tool. The housing and bushing of the top are vented at 104 to minimize bearing degradation. The bottom of the shaft has one or more paddle mechanisms 110, 120, 130, 140, 150 adapted to impart spinning motion along two different axes. Wing style paddles 112 (FIGS. 5A, 7A), churning style paddles 122 (FIGS. 5B, 6, 7B) are deployed on the bottom end, for agitating liquids when given motive force from the rotary shaft with centripetal force. The paddles have a rounded wing back design to reduce resistance, with the churning style paddles being more closely attached to their corresponding mechanisms. The paddles may be configured for either counter clockwise mixing blades or clockwise mixing blades. In the embodiments of FIGS. 5A, 6, and 7A the paddles are disposed upwardly. In an alternative embodiment shown in FIGS. SB and 7B, the paddles are disposed downwardly. Other variations of paddle shape and disposition may be made according to the mixing desired.

The counter clockwise orientation of the paddles works well in smaller tanks because they move the fluid out to the sides of the tank and that pressure they create helps keep the shaft in the center not letting it bend out towards the wall and maybe hit the wall and damage the unit. Optionally, varying sizes of mixing blades may be deployed on the bottom of the mixer tool shaft be used for different fluids. In many embodiments, various shapes of paddles are all interchangeable on the plastic shaft hub that holds the paddle blades.

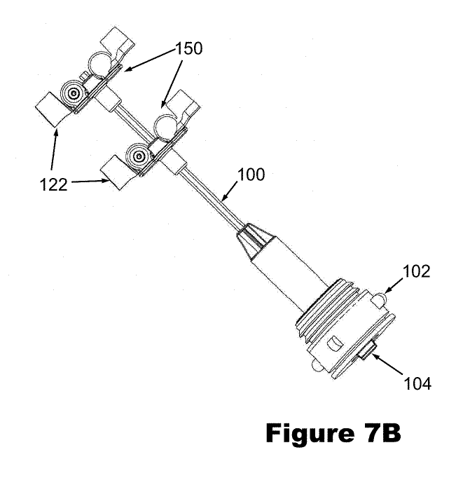

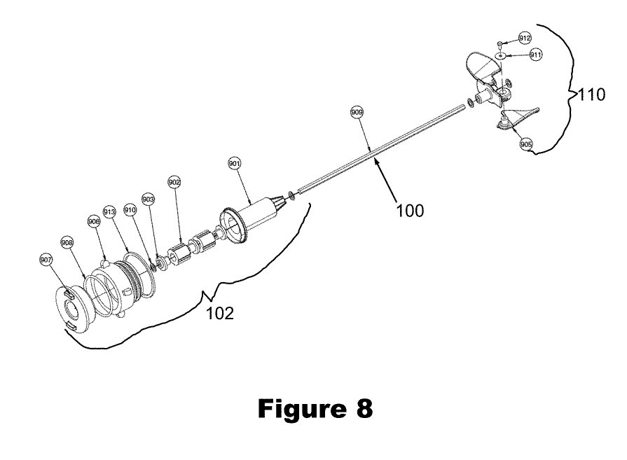

FIG. 9 shows one embodiment of the bushings of FIG. 8, with bushing 200 configured for hexagonal shaft 100 having a two-piece construction of bearings 202 fitting into each other and hub 204 which allows spin on two axis points. The exploded view of FIG. 8 shows the several component parts of one embodiment of bushing 102 and paddle mechanism 110, although various mechanical variations on the configuration of any particular paddle mechanism are possible. This disclosed arrangement reduces friction and heat that might otherwise be generated as a result of the application of a high speed of rotation of the shaft. In addition, the bodies of the bushing members are slotted which both reduces friction and allows venting of the drum.

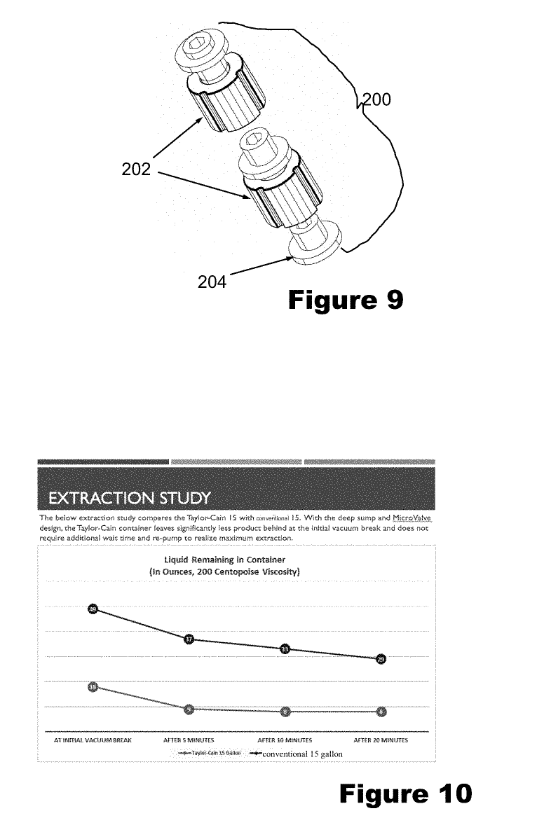

FIG. 10 compares the results of two extraction tests, one with a conventional 15 gallon drum and the other with a drum designed according to embodiments of the present invention. The inventive drum (shown on the lower line) left significantly less product behind at the initial vacuum break and did not require additional wait time and re-pumping to realize maximum extraction. The extraction study compares the inventive embodiment with a conventional embodiment. With the deep sump and valve configuration, the inventive container leaves significantly less product behind at the initial vacuum break, and after the 5, 10, and 20 minute points when measuring the liquid remaining in the container in ounces, with 200 centopoise viscosity.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A drum assembly including a barrel having a top and a bottom, the top having a valve port and a mixer port, the barrel having an interior storage compartment extending from the top to the conical center of the bottom for extracting liquid from the barrel, the bottom of the interior storage compartment having a downwardly conical shape, and the mixer port supporting a mixer tool having a shaft with a mixing paddle extending into the interior storage compartment of the barrel.

2. The drum assembly of claim 1 wherein the shaft extends to the bottom.

3. The drum assembly of claim 1 wherein the mixing paddle has a winged configuration.

4. The drum assembly of claim 1 wherein the mixing paddle has a churning configuration.

5. The drum assembly of claim 1 wherein the top includes a plurality of ribs.

6. The drum assembly of claim 1 wherein the top includes a handle.

7. The drum assembly of claim 1 wherein the shaft has a bearing portion located at the top of the shaft extending to the mixer port.

8. The drum assembly of claim 1 further comprising a mixing mechanism disposed on the bottom end of the shaft.

9. The drum assembly of claim 8 wherein the end of the shaft positions the mixing mechanism at the conical center of the bottom.

10. The drum assembly of claim 9 wherein the mixing mechanism is configured for attaching to the mixing paddle.

11. The drum assembly of claim 10 wherein the mixing mechanism is configured for alternatively orienting the mixing paddle for either clockwise or counter-clockwise rotation.

12. The drum assembly of claim 11 further comprising a second mixing paddle attached to the mixing mechanism.

13. The drum assembly of claim 8 further comprising a second mixing mechanism disposed on the shaft between the bottom end of the shaft and the mixer port.
